(19) United States
(12) Patent Application Publication
(10) Pub. No.: US 2007/0217829 A1
(43) Pub. Date: Sep. 20, 2007

(54) Image forming apparatus

(75) Inventor: Keiichi Tanida, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/724,932

(22) Filed: Mar. 16, 2007

(30) Foreign Application Priority Data
Mar. 17, 2006 (JP) 2006-073884

(51) Int. Cl. G03G 15/01

(52) U.S. Cl. 399/299

(57) ABSTRACT

A tandem image forming apparatus, comprising multiple image forming units placed along the travelling direction of a transfer medium for transferring toner images in various colors one by one onto the transfer medium, wherein a toner (T1) containing a higher fatty acid metal salt is stored at least in the image forming unit placed most downstream in the travelling direction of the transfer medium, and, when the concentration of the higher fatty acid metal salt in the toner (T1) is designated as X1, the concentration of the higher fatty acid metal salt in the toner (Tn) stored in the image forming unit placed most upstream in the travelling direction of the transfer medium as Xn, and the concentration of the higher fatty acid metal salt in the toner (Tm) in an image forming unit placed between the most downstream image forming unit and the most upstream image forming unit as Xm, X1, Xm, and Xn satisfy the relationships represented by the following Formulae (I) and (II).

X1>Xn (I)

X1≧Xm≧Xn (II)

### BACKGROUND OF THE INVENTION

1. Field of the Invention

The present invention relates to a tandem image forming apparatus useful for copying machine, laser printer, facsimile, or multifunctional complex machine in which an electrophotographic process is used.

2. Description of the Related Art

Traditionally in forming a color image, for example, a method of forming four images different in color (e.g., black (B), yellow (Y), cyan (C), and magenta (M)) in order on a photosensitive body in such a manner that the images in the various colors overlap each other on a single photosensitive body (image carrier) has been used. However, the method had a problem that an extended; period was needed for formation of the final color image.

For that reason, there have been recently employed more frequently so-called tandem image forming apparatuses having multiple photosensitive bodies, in which a color image is formed by forming elemental color images different in color on the respective photosensitive bodies by simultaneous scanning exposure of the photosensitive bodies to multiple photo beams, followed by superimposing the elemental color images on a single transfer medium. For example, there have been widely used tandem image forming apparatuses having a travelling intermediate transfer body (transfer medium) allowing transfer of the toner images in various colors one by one, multiple image forming units which are placed along the travelling direction of the intermediate transfer body and respectively have image carriers carrying toner images in various colors, a primary transfer means of transferring the toner image on the image carrier onto the intermediate transfer body, and a secondary transfer means of retransferring the toner image on the intermediate transfer body onto the recording medium.

Generally, as the image carrier for use in such an image forming apparatus, an amorphous silicon drum is known to be advantageous and thus, used widely, because it allows elongation of the life of machine and reduction in running cost easily. It is because the amorphous silicon drum, which has high surface hardness, is resistant to surface abrasion even when polished with the inorganic fine particles present on the toner surface and retains its favorable properties for an extended period of time.

However, the amorphous silicon drum, which is higher in friction resistance, sometimes caused a phenomenon that the linear image formed with transferred toner is missing or hollowed in its center (hereinafter, referred to as “hollow character phenomenon”) when used in a tandem image forming apparatus. In the tandem image forming apparatus, the toner transferred on the transfer medium in the most upstream image forming unit in the travelling direction of the transfer medium becomes in contact with the image carrier in the image forming unit downstream thereof. When the image carrier is a amorphous silicon drum higher in friction resistance, the outmost layer of the transferred toner deposited on the drum during the contact becomes more easily separable. As a result, the toner linear image on the transfer medium is removed in the center, causing the hollow character phenomenon.

It would be effective to reduce the friction resistance of the amorphous silicon drum for prevention of the hollow character phenomenon. A method of adding a metal soap to the toner used was studied for reduction of the friction resistance of image carrier. For example, Patent Document 1 (Japanese Unexamined Patent Publication No. 2001-51443) discloses a method of adding a metal soap having a particular particle diameter, together with titanium oxide or silica, to the developer. Alternatively, Patent Document 2 (Japanese Unexamined Patent Publication No. 2005-31243) discloses a method of adding a metal soap to a toner used in an image forming apparatus having a rotational developing device, wherein the amount of the metal soap in the toners is optimized according to the revolving multiple developing units.

However, generally, a large amount of metal soap should be used to obtain the advantageous effects of the metal soap sufficiently, and a large amount of metal soap was used also in the methods disclosed in Patent Documents 1 and 2. Presence of a large amount of metal soap causes, for example, a problem of deterioration in electrostatic property in Patent Document 1 and a problem of deposition of the metal soap on the blade surface in Patent Document 2. Patent Document 1 aims to solve the problem by reducing the diameter of the metal soap, while Patent Document 2 by optimizing the content of the metal soap in the toners according to the revolving multiple developing units.

For control of the hollow character phenomenon that may occur also in tandem image forming apparatuses using an amorphous silicon drum, it was necessary to add a large amount of metal soap to the toner to reduce the friction resistance of the drum sufficiently to the degree prohibiting hollow character phenomenon. In addition, the metal soap added to the toner in a large amount also caused another problem of incomplete electrification.

### SUMMARY OF THE INVENTION

In view of the above problems residing in the prior arts, it is an object of the present invention to provide a tandem image forming apparatus that prohibits the hollow character phenomenon or incomplete electrification when an amorphous silicon drum is used therein.

An aspect of the present invention is directed to a tandem image forming apparatus, comprising multiple image forming units placed along the travelling direction of a transfer medium for transferring toner images in various colors one by one onto the transfer medium, wherein a toner (T1) containing a higher fatty acid metal salt is stored at least in the image forming unit placed most downstream in the travelling direction of the transfer medium, and, when the concentration of the higher fatty acid metal salt in the toner (T1) is designated as X1, the concentration of the higher fatty acid metal salt in the toner (Tn) stored in the image forming unit placed most upstream in the travelling direction of the transfer medium as Xn, and the concentration of the higher fatty acid metal salt in the toner (Tm) stored in an image forming unit placed between the most downstream image forming unit and the most upstream image forming unit is designated as Xm, X1, Xm, and Xn satisfy the relationships represented by the following Formulae (I) and (II):

X1>Xn (I)

X1≧Xm≧Xn (II)

These and other objects, features, aspects, and advantages of the present invention will become more apparent upon reading the following detailed description along with the accompanying drawings.

### BRIEF DESCRIPTION OF THE DRAWINGS

FIG. 1 is a schematic view illustrating an example of the image forming apparatus according to the present invention.

### DETAILED DESCRIPTION OF THE PREFERRED EMBODIMENTS

In order to reduce the friction resistance of image carrier and prevent the hollow character phenomenon by adding a higher fatty acid metal salt as a metal soap to the toner, the inventors have conducted intensive studies aiming at preventing the hollow character phenomenon reliably and concurrently keeping the content of the higher fatty acid metal salt in the toner low enough to prevent incomplete electrification. As a result, they have found that the possibility of the phenomenon of toner separation by contact between the image carrier and the toner on transfer medium varies according to the position of the image forming unit placed in the travelling direction of the transfer medium. The amount of the toner transferred onto the transfer medium increases from upstream to downstream in the travelling direction of the transfer medium, and thus, the toner separation by contact between the image carrier and the toner on transfer medium occurs more frequently on the image forming units located downstream.

Based on the finding, the inventors have found that it was possible to reduce the friction resistance of image carrier effectively by changing the concentration of the higher fatty acid metal salt contained in the toners stored in respective image forming units according to the positions of respective image forming units. It was thus possible to prevent the hollow character phenomenon and the incomplete electrification while keeping the higher fatty acid metal salt content low, by controlling the concentration of the higher fatty acid metal salt higher in the toners contained in the downstream image forming units and lower in those in the upstream image forming units. The aspect of the present invention has been made based on the above finding.

Hereinafter, favorable embodiments of the present invention will be described in detail.

In an embodiment of the present invention, the image forming apparatus is a tandem image forming apparatus in which multiple image forming units are so placed along the travelling direction of the transfer medium that toner images in various colors are transferred onto the transfer medium one by one, wherein a toner (T1) containing a higher fatty acid metal salt is stored at least in the image forming unit placed most downstream in the travelling direction of the transfer medium. Further, when the concentration of the higher fatty acid metal salt in the toner (T1) is designated as X1, the concentration of the higher fatty acid metal salt in the toner (Tn) stored in the most upstream image forming unit in the travelling direction of the transfer medium is designated as Xn, and the concentration of the higher fatty acid metal salt in the toner (Tm) stored in an image forming unit placed between the most downstream image forming unit and the most upstream image forming unit is designated as Xm, X1, Xm, and Xn satisfy the relationships represented by the following Formulae (I) and (II):

X1>Xn (I)

X1≧Xm≧Xn (II)

The image forming apparatus in the present embodiment is a tandem image forming apparatus in which multiple image forming units are so placed along the travelling direction of the transfer medium that the toner images in various colors are transferred onto the transfer medium one by one. Tandem image forming apparatuses include 1) those by a method in which the transfer medium is an intermediate transfer body such as transfer belt and the toner images primarily transferred from respective image forming units onto the intermediate transfer body are retransferred onto a recording medium such as paper (hereinafter, referred to as “indirect transfer method”), and 2) those by a method in which the transfer medium is a recording medium such as paper and the toner image is transferred from each image forming unit onto the recording medium such as paper (hereinafter, referred to as “direct transfer method”); and the image forming apparatus in the present embodiment may be an apparatus by any method, if it is a tandem apparatus. Thus, the transfer medium may be an intermediate transfer body such as transfer belt or a recording medium such as paper.

As an embodiment of the image forming apparatus according to the present invention, a tandem image forming apparatus by the indirect transfer method will be described in detail with reference to drawings.

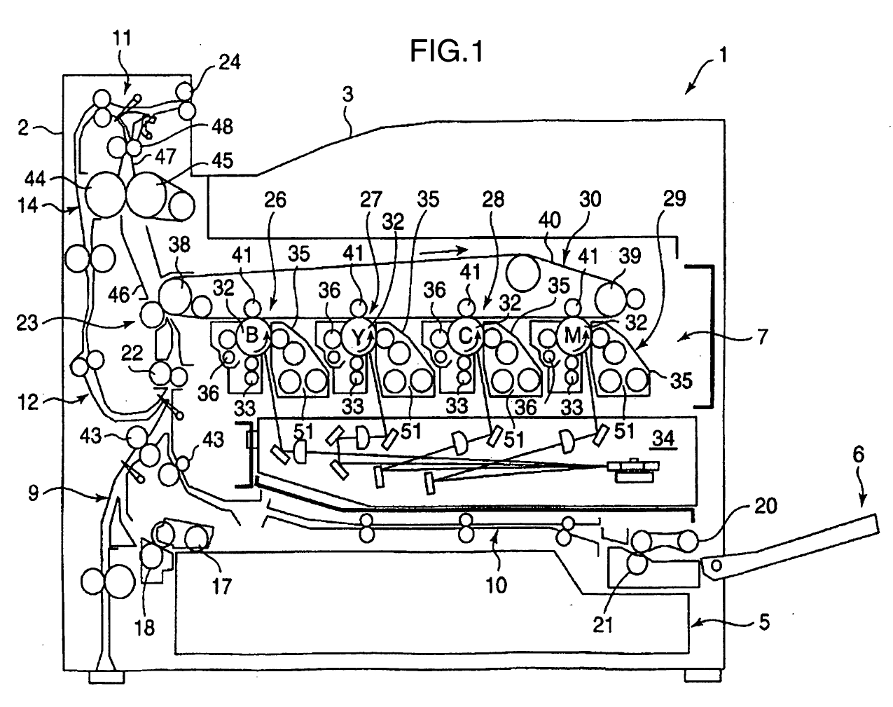

Such a tandem image forming apparatus by the indirect transfer method generally has a travelling intermediate transfer body (transfer medium) allowing transfer of toner images in various colors one by one, multiple image forming units placed along the travelling direction of the intermediate transfer body, each having an image carrier carrying a toner image in a respective color, a primary transfer means of transferring the toner image on the image carrier onto the intermediate transfer body, and a secondary transfer means of retransferring the toner image on the intermediate transfer body onto a recording medium. FIG. 1 is a schematic view illustrating the internal configuration of a color printer, a tandem image forming apparatus 1 by the indirect transfer method.

The image forming apparatus 1 has a square box-shaped housing 2 in which a color image is formed (printed) on paper (recording medium). In the housing 2, there are a paper-feeding cassette 5 for storing paper in the lower region, a stack tray 6 for manual paper feeding in the intermediate region, and an image forming unit 7 in which an image is formed on the paper based on the image data such as of character or picture transmitted from an external apparatus in the upper region. On the top of the housing 2, there is also a paper-discharging unit (discharge tray) 3 where the color image-carrying paper is discharged.

The paper-feeding cassette 5, into which paper is filled as the cassette is withdrawn out of the housing 2, accommodates at least two kinds of paper different in size in the paper-feeding direction selectively. The stack tray 6 is a tray for placing the manually-fed paper.

The paper stored in the paper-feeding cassette 5 is fed one by one with a paper feed roller 17 and friction rollers 18 and conveyed to the image forming unit 7 by multiple conveyor rollers 43 placed at predetermined positions along the first conveying route 9. On the other hand, the paper placed on the stack tray 6 is fed one by one with a pickup roller 20 and friction rollers 21 and conveyed to the image forming unit 7 by multiple conveyor rollers 43 placed along the second conveying route 10. Then, the timing of image forming in the image forming unit 7 and the paper-feeding operation are synchronized by a resist roller 22 formed at the position downstream of the junction of the first conveying route 9 and the second conveying route 10 and upstream of the image forming unit 7 (specifically, upstream of secondary transfer roller (secondary transfer means) 23 described below).

The image forming unit 7 has image forming units 26 to 29 forming toner images in various colors and a transfer conveyor unit 30 transferring a full-color superimposed toner image of the toner images in various colors formed in respective image forming units 26 to 29 onto the paper (recording medium). Specifically, the image forming units 26 to 29 in various colors are placed along the below-described primary transfer belt (intermediate transfer body) 40 traveling clockwise at the transfer conveyor unit 30 in its travelling direction. The order of the colors in image forming units 26 to 29 is normally, not particularly limited, but, in FIG. 1, image forming units respectively in black (B), yellow (Y), cyan (C), and magenta (M), are formed upward from downstream in the travelling direction of the primary transfer belt (intermediate transfer body) 40.

Each of the image forming units 26 to 29 has a photosensitive body drum (image carrier) 32, an electrification unit 33 placed at position facing the peripheral face of the photosensitive body drum (image carrier) 32, a laser-scanning unit 34 placed downstream of the electrification unit 33 that irradiates laser beam at a particular position on the peripheral face of the photosensitive body drum (image carrier) 32, a development unit 35 downstream of the irradiation position of the laser beam from the laser-scanning unit 34 placed at the position facing the peripheral face of the photosensitive body drum 32, and a cleaning unit 36 downstream of the development unit 35 placed at a position facing the peripheral face of the photosensitive body drum 32. The development unit 35 in each image forming unit 26 to 29 has a toner box 51 in a respective color. The photosensitive body drum 32 in each image forming unit 26 to 29 is rotated counterclockwise by a drive motor (not shown in the Figure).

The transfer conveyor unit 30 has a rear roller (drive roller) 38 placed at a position close to the image forming unit 26, a front roller (follower roller) 39 placed at a position closed to the image forming unit 29, a primary transfer belt (intermediate transfer body) 40 extending around the rear roller 38 and the front roller 39, primary transfer rollers (primary transfer means) 41 placed on the other side of the primary transfer belt 40 in contact with respective photosensitive body drums 32 under pressure at positions downstream of the development units 35 of the photosensitive body drums 32 of image forming unit 26 to 29, and a secondary transfer roller (secondary transfer means) 23 in contact with the rear roller (drive roller) 38 under pressure via the paper (recording medium) fed from the primary transfer belt 40 and the resist roller 22.

In each image forming unit 26 to 29, the surface of the photosensitive body drum (image carrier) 32 is electrostatically charged at the position facing the electrification unit 33. Then, laser beam is irradiated from the laser-scanning unit 34 on the electrification region, based on the image data to be formed, forming an electrostatic latent image on the photosensitive body drum (image carrier) 32. The electrostatic latent image formed is developed at the position facing the development unit 35, leaving a toner image in a respective color on the photosensitive body drum (image carrier) 32. Then, toner images in various colors are transferred one by one on the primary transfer belt (intermediate transfer body) 40 at the positions of the primary transfer rollers 41 of respective image forming units 26 to 29, and thus, the primary transfer belt (intermediate transfer body) 40 travelling from the most downstream image forming unit 26 has a full-color toner image. The full-color toner image on the primary transfer belt (intermediate transfer body) 40 is retransferred onto the paper (recording medium) fed from the resist roller 22 at the position of the secondary transfer roller (secondary transfer means) 23. The toner remaining on the peripheral face of the photosensitive body drum (image carrier) 32 after image transfer to the primary transfer belt (intermediate transfer body) 40 in each image forming unit 26 to 29 is removed by a cleaning unit 36.

The paper carrying the image formed in the image forming unit 7 is sent to the fixing unit 14 placed in the top left region and processed for fixing the formed image on paper. The fixing treatment is performed by applying heat and pressure on the toner image transferred on the paper in the image forming unit 7. The fixing unit 14 has a fixing roller 44 heated by a built-in heater, a pressure roller 45 in contact with the fixing roller 44 under pressure, a pre-conveying route 46 for guiding the paper from the secondary transfer roller (secondary transfer means) 23 to the space between the fixing roller 44 and the pressure roller 45 placed upstream thereof, and a post-conveying route 47 guiding the paper coming out of the space between the fixing roller 44 and the pressure roller 45 to the side of the third conveying route 11 placed downstream thereof.

The paper fixed in the fixing unit 14 is conveyed by a conveyor roller 48 placed at a predetermined position in the third conveying route 11 and discharged by a discharge roller 24 placed in the outlet side into the paper-discharging unit 3. The fixed paper may be sent as needed into the fourth conveying route 12 and reversed there, and an image be formed on the face opposite to the face previously image-formed, once again by the secondary transfer roller (secondary transfer means) 23, and the paper be discharged out of the fixing unit 14 through the third conveying route 11 into the paper-discharging unit 3.

Preferably in the image forming apparatus in the present embodiment, at least the most downstream image forming unit (i.e., image forming unit 26 in FIG. 1, hereinafter, the image forming unit may be referred to as “unit (1)”) in the travelling direction of the transfer medium (i.e., intermediate transfer body, the primary transfer belt 40 in FIG. 1) contains a toner (T1) containing a higher fatty acid metal salt. By adding the higher fatty acid metal salt at least to the toner (T1) stored in the most downstream unit (1), it is possible to effectively prevent the hollow character phenomenon, which occurs when the toner transferred on the transfer medium deposits on and then is removed from the image carrier.

Examples of the higher fatty acid metal salts include metal salts of a straight-chain saturated fatty acid having 12 to 22 carbon atoms such as lauric acid, myristic acid, palmitic acid, stearic acid, or behenic acid. Among them, metal salts of stearic acid are preferable. Examples of the metals of the metal salt include non-alkali metals such as zinc, magnesium, calcium, and aluminum. Zinc is particularly preferable. In particular, zinc stearate is preferable, because it reduces the friction resistance of amorphous silicon drum effectively. The higher fatty acid metal salts may be used alone or in combination of two or more. When the fatty acid is stearic acid, a stearic amide derivative such as stearic amide or stearic bisamide may be used in addition to a metal stearate salt such as zinc stearate, magnesium stearate or calcium stearate.

In the image forming apparatus of the present embodiment, when the concentration of the higher fatty acid metal salt in the toner (T1) is designated as X1, the concentration of the higher fatty acid metal salt in the toner (Tn) stored in the most upstream image forming unit (image forming unit 29 in FIG. 1, hereinafter, referred to as “unit (n)”) in the travelling direction of the transfer medium is designated as Xn, and the concentration of the higher fatty acid metal salt in the toner (Tm) stored in an image forming unit (image forming units 27 and 28 in FIG. 1, hereinafter referred to as “unit (m)”) placed between the most downstream image forming unit (1) and the most upstream image forming unit (n) is designated as Xm, X1, Xm, and Xn should satisfy the relationships represented by the following Formulae (I) and (II).

X1>Xn (I)

X1≧Xm≧Xn (II)

It is possible to prevent hollow character phenomenon and incomplete electrification at the same time, by using the toners having a higher fatty acid metal salt concentration wherein X1, Xn, and Xm satisfy the relationships of the Formulae (I) and (II), in respective image forming units.

When there are multiple units (m) above (when there are multiple image forming units between the most downstream unit (1) and the most upstream unit (n)), Xm represents the concentration of the individual higher fatty acid metal salt in the toners stored in multiple units (m), and each concentration of the individual higher fatty acid metal salt should satisfy the requirement of the Formula (II) as Xm. For example, as shown in FIG. 1 in an image forming apparatus having four image forming units, both of the image forming units 27 and 28 shown in FIG. 1 correspond to the units (m), and thus, both the concentration of the higher fatty acid metal salt in the toner stored in the image forming unit 27 and that in the toner stored in the image forming unit 28 should satisfy the requirement of the Formula (II) as Xm.

In addition, in the present embodiment, when there are multiple image forming units (units (m1, m2, . . . )) between the most downstream unit (1) and the most upstream unit (n), the concentration of the higher fatty acid metal salt in the toner of each unit (Tm1, Tm2, . . . ) is preferably arranged in such a way that the upstream concentration is similar to or smaller than the next downstream concentration. Thus, among multiple units (m1, m2, . . . , m(n−1)) placed between the most downstream unit (1) and the most upstream unit (n), when the concentration of the higher fatty acid metal salt in the toner of each unit (m1), unit (m2), . . . , or unit (m(n−1)) in the direction upstream from the most downstream side is designated as Xm1, Xm2, . . . , or Xm (n−1), they preferably satisfy the following Formula (III):

Xm1≧Xm2≧ . . . ≧Xm(n−1) (III)

It is possible to prevent hollow character phenomenon and incomplete electrification more reliably in this manner.

The concentration of the higher fatty acid metal salt in the toner stored in each image forming unit is not particularly limited, if it satisfies the relationships of Formulae (I) and (II) described above. However, the concentration of the higher fatty acid metal salt contained in the toner (T1) stored at least in the most downstream unit (1) is preferably 0.01 to 0.5 mass % with respect to the toner particle. It is more preferably 0.03 to 0.3 mass % and still more preferably 0.03 to 0.2 mass % with respect to the toner particle.

As for the toners other than toner (T1), for example, when there are four image forming units as shown in FIG. 1, a toner containing the higher fatty acid metal salt at a concentration of 0.05 to 0.1 mass % with respect to the toner particle is preferably used in the image forming unit (image forming unit 27 in FIG. 1) second from the most downstream unit. Alternatively in the image forming unit (image forming unit 28 in FIG. 1) third from the most downstream unit, use of a toner containing the higher fatty acid metal salt at a concentration of 0.02 to 0.05 mass % with respect to the toner particle is preferable. In addition, a toner containing the higher fatty acid metal salt at a concentration of 0.001 to 0.02 mass % with respect to the toner particle is preferably used in the most upstream image forming unit (n) (image forming unit 29 in FIG. 1). The concentration of the higher fatty acid metal salt in the toners other than toner (T1) may be lower than the range above. The toners other than toner (T1) may contain no higher fatty acid metal salt (Xn is 0, or Xn and Xm are 0 in Formulae (I) and (II)). However, for more reliable prevention of incomplete electrification, all toners preferably satisfy the relationships represented by Formulae (I) and (II) and contain the higher fatty acid metal salt at concentration up to 0.5 mass % with respect to the toner particle.

The content of the higher fatty acid metal salt can be determined quantitatively by fluorescent X-ray analysis, by using a calibration curve prepared with standard samples.

The image carrier for use in the present embodiment is not particularly limited, and an organic photosensitive body having an organic photosensitive layer at least containing a charge generation agent and a charge transport agent on a conductive base material, or an inorganic photosensitive body having an amorphous silicon layer, a glassy silicon layer, a Se-based photosensitive layer, a ZnO photosensitive layer, a CdS-based photosensitive layer, or the like, may be used. Among them, use of an amorphous silicon drum having an amorphous silicon layer is preferable for obtaining the advantageous effects of the present embodiment effectively. Thus when an amorphous silicon drum higher in friction resistance is formed as an image carrier in each image forming unit, the toner transferred on the transfer medium often deposits and easily separates, often resulting in significant hollow character phenomenon, but it is possible to prevent such a phenomenon effectively in the embodiment.

The toner stored in each image forming unit in the present embodiment may contain any other components other than the higher fatty acid metal salt, if the toner satisfies the above requirement of containing the higher fatty acid metal salt. The toner is produced, for example, by preparing toner particles by using various ingredients such as binder resin, magnetic powder or colorant, releasing agent, and charge control agent and externally adding the higher fatty acid metal salt described above and other components described below. The blending rate of respective components for the toner is decided properly in the technical range known in the art. The toner in the present embodiment may be used, for example, as a mono-component developer or in a two-component developer in combination with a magnetic carrier (e.g., iron powder or ferrite).

Examples of the binder resins for use include thermoplastic resins such as polystyrene resins, acrylic resins, styrene-acrylic copolymers, polyethylene resins, polypropylene resins, polyvinyl chloride resins, polyester resins, polyamide resins, polyurethane resins, polyvinylalcohol resins, vinylether resins, N-vinyl resins, and styrene-butadiene resins. A thermosetting resin may be used partially as the binder resin, in addition to the thermoplastic resin. Examples of the thermosetting resins include epoxy resins, cyanate resins and the like.

Examples of the magnetic powders include ferromagnetic metals such as iron, cobalt, and nickel including ferrite and magnetite, alloys of these metal elements, compounds containing these metal elements, alloys containing no ferromagnetic element that become ferromagnetic by suitable heat treatment, chromium dioxide and the like. The magnetic powder is preferably a fine powder having an average particle diameter in the range of 0.1 to 1 μm, preferably 0.1 to 0.5 μm. Alternatively, a magnetic powder surface-treated with a surface finishing agent such as titanium-based or silane-based coupling agent may be used.

Examples of the colorants include black colorants such as carbon black; yellow colorants including nitro pigments such as such as naphthol yellow S, azo pigments such as Hanza Yellow 5G, Hanza Yellow 3G, Hanza yellow G, benzidine yellow G, and Vulcan Fast Yellow 5G, inorganic pigments such as iron oxide yellow and Chinese yellow, those listed in Color Index such as C.I. Pigment Yellow 12, C.I. Pigment Yellow 180, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19, and C.I. Solvent Yellow 21; cyan colorants including those listed in Color Index such as C.I. Pigment Blue 15, C.I. Pigment Blue 15-1, C.I. Pigment Blue 15-3, C.I. pigment blue 16, C.I. Solvent Blue 55, C.I. Solvent Blue 70, C.I. Direct Blue 86, and C.I. Direct Blue 25; magenta colorants including those listed in Color Index such as C.I. Pigment Red 81, C.I. Pigment Red 122, C.I. Pigment Red 57, C.I. pigment red 49, C.I. Pigment Red 238, C.I. Solvent Red 49, C.I. Solvent Red 19, C.I. Solvent Red 52, C.I. Basic Red 10, and C.I. Disperse Red 15; and the like.

Examples of the releasing agents include vegetable waxes such as carnauba wax, sugar wax, and Japan wax; animal waxes such as beeswax, insect wax, spermaceti wax, and wool wax; Fischer-Tropsch wax having an ester group on the side chain; synthetic hydrocarbon waxes such as polyethylene wax and polypropylene wax; and the like.

The charge control agent may be an agent for positive or negative charge. Typical examples of the charge control agents for positive charge include azine compounds such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes of azine compound such as Azine Fast Red FC, Azine Fast Red 12BK, Azine Violet BO, Azine Brown 3G, Azine Light Brown GR, Azine dark Green BH/C, Azine Deep Black EW and Azine Deep Black 3RL; nigrosine compounds such as nigrosine, nigrosine salts, and nigrosine derivatives; acidic dyes of nigrosine compound such as Nigrosine BK, Nigrosine NB, and Nigrosine Z; metal salts of naphthenic or higher fatty acid; alkoxylated amines; alkyl amides; quaternary ammonium salts such as benzylmethylhexyldecylammonium, and decyltrimethylammonium chloride; resins or oligomers having a quaternary ammonium salt, a carboxylate salt or a carboxyl group as the functional group (more specifically, styrene resins having a quaternary ammonium salt, acrylic resins having a quaternary ammonium salt, styrene-acrylic resins having a quaternary ammonium salt, polyester resins having a quaternary ammonium salt, styrene resins having a carboxylate salt, acrylic resins having a carboxylate salt, styrene-acrylic resins having a carboxylate salt, polyester resins having a carboxylate salt, polystyrene resins having a carboxyl group, acrylic resins having a carboxyl group, styrene-acrylic resins having a carboxyl group, polyester resins having a carboxyl group, etc.), and the like. Alternatively, examples of the negative charge-controlling agents include organic metal complexes and chelate compounds; typical examples thereof include aluminum acetylacetonate, iron (II) acetylacetonate, chromium 3,5-di-tert-butylsalicylate, and the like; acetylacetone metal complexes and salicylic acid-based metal complexes or the salts thereof are preferable; and salicylic acid-based metal complexes or salicylic acid metal salts are particularly preferable.

Examples of the other components externally added to the toner particles include silica powder, metal oxides such as titanium oxide, aluminum oxide, magnesium oxide, zinc oxide, strontium titanate, barium titanate, magnesium titanate, and calcium titanate, and the like.

Although the favorable embodiments of the present invention have so far been described, the description above is only for exemplification in all aspects, and the present invention is not restricted thereby. It is to be construed that an unlimited number of modifications not described above are embodied without departing from the scope of the present invention.

### EXAMPLES

Hereinafter, the present invention will be described more specifically with reference to Examples, but it should be understood that the present invention is not limited by these Examples.

The “part” in the Examples below means “part by mass” unless specified otherwise.

### Example 1

First, developers in four colors were prepared in the following manner:

### (Preparation of Black Developer (Indicated as “Black” in Table 1))

A mixture of 100 parts of a polyester resin obtained by condensation of bisphenol A and fumaric acid, 4 parts of carbon black (“MA-100” available from Mitsubishi Chemical Corp.), 3 parts of Fischer-Tropsch wax (“FT-100”, available from Nippon Seiro), and 2 parts of a quaternary ammonium salt compound (“P-51”, available from Orient Chemical Industries) were stirred in a Henschel Mixer (manufactured by Mitsui Mining Com.) for 2 minutes, and melt-extruded by a biaxial extruder into a toner blend. The toner blend obtained was pulverized in an air-flow pulvelizer and classified in an air classifier, to give toner particles. The volume average diameter of the toner particles obtained, as determined with Multisizer III, was 8.2 μm.

Then, 1 part of silica particles (“TG-820”, available from Cabot), 1 part of titanium oxide (“TTO-55A”, available from Ishihara Sangyo Kaisha), and 0.1 part of zinc stearate (available from NOF Corporation) were added to 100 parts of the toner particle obtained, and the mixture was pulverized in a Henschel Mixer (manufactured by Mitsui Mining Com.) at 3,000 rpm for 10 minutes, to give a toner.

The toner obtained and a ferrite carrier (“EF-60B”, available from PowderTech Corp.) having an average particle diameter of 60 μm previously coated with a silicone resin (“KR251”, available from Shin-Etsu Silicones) were blended at a toner concentration of 5 mass %, and the mixture was agitated uniformly, to give a two-component developer.

### (Preparation of Yellow Developer (Indicated as “Yellow” in Table 1))

Toner particles were prepared in a similar manner to the black developer, except that 4 parts of carbon black was replaced with 2 parts of a yellow pigment (C.I. Pigment Yellow 180). The volume average diameter of the toner particles obtained, as determined by using Multisizer III, was 8.4 μm.

Then, a toner and then a developer were prepared in a similar manner to the black developer, except that the amount of zinc stearate added was changed to 0.07 parts.

### (Preparation of Cyan Developer (Indicated as “Cyan” in Table 1))

Toner particles were prepared in a similar manner to the black developer, except that 4 parts of carbon black was replaced with 3 parts of a cyan pigment (C.I. Pigment Blue 15-3). The volume average diameter of the toner particles obtained, as determined by using Multisizer III, was 8.5 μm.

Then, a toner and then a developer were prepared in a similar manner to the black developer, except that the amount of zinc stearate added was changed to 0.04 parts.

### (Preparation of Magenta Developer (Indicated as “Magenta” in Table 1))

Toner particles were prepared in a similar manner to the black developer, except that 4 parts of carbon black was replaced with 3 parts of a magenta pigment (C.I. Pigment Red 238). The volume average diameter of the toner particles obtained, as determined by using Multisizer III, was 8.3 μm.

Then, a toner and then a developer were prepared in a similar manner to the black developer, except that the amount of zinc stearate added was changed to 0.01 parts.

### (Evaluation)

An image was formed in a tandem color image forming apparatus (modified FS-5016N, having a built-in amorphous silicon photosensitive body) manufactured by Kyocera Mita Corp. in the structure shown in FIG. 1, while the developers in four colors obtained above were supplied in the order of black, yellow, cyan, and magenta upward from downstream in the travelling direction of the intermediate transfer body, and the image was evaluated in the following tests.

### <Hollow Character (Initial and After Printing on 100,000 Sheets)>

The initial hollow character was determined by printing an image on 1,000 sheets at a printing ratio of 5%, followed by examining presence of hollow characters by visual observation under a hand lens at a magnification of 10 times, and the result was evaluated according to the following criteria:

### ⊚: No hollow character generated

### ∘: No hollow character generated, but some irregularity on line of character

### Δ: Several hollow characters observed on an A4 printed image

x: Missing in the center of the character formed by the downstream image forming unit.

The hollow character after printing on 100,000 sheets was determined similarly, after printing on 100,000 sheets at a printing ratio of 5%.

### <Image Density (Initial and After Printing on 100,000 Sheets)>

An image was formed immediately after the machine was turned on and stabilized, and then, the initial image density was determined. Solid images of 2 cm×2 cm in size were formed at three positions, left, center and right, and the reflection density from the three images was determined by using “RD-19I” manufactured by Gretag Macbeth, and the average was used as the image density. The results are evaluated, based on the value, according to the following criteria.

The image density after printing on 100,000 sheets was determined, after performing an image-output test of printing an image at a printing density of 4% on 100,000 sheets, by measuring the image density of the image in the similar way for the developers in various colors, and evaluated according to the following criteria,

### ∘: Image density of 1.30 or more

### Δ: Image density of 1.20 or more and less than 1.30

x: Image density of less than 1.20

### <Electrification Amount (Initial and After Printing on 100,000 Sheets) and Toner Scattering>

An image was printed after the machine was turned on and stabilized, and then, the initial electrification amount (μC/g) was determined for the developers in various colors by using a suction charge spectrometer (manufactured by Trek).

After performing an image-output test at a printing density of 4% on 100,000 sheets, the electrification amount (μC/g) after printing on 100,000 sheets was determined in the similar way for the developers in various colors. Then, it was also examined whether there was no trouble during image output on 100,000 sheets. There was no such a trouble, unless specified otherwise.

The toner scattering was determined by visual observation of toner scattering, and evaluated according to the following criteria.

### ∘: No toner scattering observed

### Δ: Some toner scattering observed

x: Significant toner scattering observed

Evaluation results are summarized in Table 1.

### Example 2

A black developer was prepared in a similar manner to Example 1, except that the amount of zinc stearate added to the toner particle in production of the black developer was changed to 0.5 part. Image evaluation was performed in a similar manner to Example 1, except that this developer was used. Results are summarized in Table 1.

### Example 3

Yellow and cyan developers were prepared in a similar manner to Example 1, except that, the amount of zinc stearate added to the toner particle in production of the yellow developer was changed to 0.06 part and the amount of zinc stearate added to the toner particle in production of the cyan developer to 0.07 part. Image evaluation was performed in a similar manner to Example 1, except that these developers were used. Results are summarized in Table 1.

### Example 4

Yellow, cyan and magenta developers were prepared in a similar manner to Example 1, except that the amount of zinc stearate added to the toner particle in production of the yellow, cyan and magenta developers was changed to 0 part. Image evaluation was performed in a similar manner to Example 1, except that these developers were used. Results are summarized in Table 1.

### Comparative Example 1

Black and yellow developers were prepared in a similar manner to Example 1, except that the amount of zinc stearate added to the toner particle in production of the black developer was changed to 0.07 part and the amount of zinc stearate added to the toner particle in production of the yellow developer to 0.1 part. Image evaluation was performed in a similar manner to Example 1, except that these developers were used. Results are summarized in Table 1.

### Comparative Example 2

Black, yellow and cyan developers were prepared in a similar manner to Example 1, except that the amount of zinc stearate added to the toner particle in production of the black, yellow and cyan developers was changed to 0 part. Image evaluation was performed in a similar manner to Example 1, except that these developers were used. Results are summarized in Table 1.

### Comparative Example 3

Black, yellow and cyan developers were prepared in a similar manner to Example 1, except that the amount of zinc stearate added to the toner particle in production of the black developer was changed to 0.01 part, that in production of the yellow developer to 0.04 part, and that in production of the cyan developer to 0.07 part. Image evaluation was performed in a similar manner to Example 1, except that these developers were used. Results are summarized in Table 1.

### Comparative Example 4

A black developer was prepared in a similar manner to Example 1, except that the amount of zinc stearate added to the toner particle in production of the black developer was changed to 0.06 part. Image evaluation was performed in a similar manner to Example 1, except that this developer was used. Results are summarized in Table 1.

TABLE 1

| | | | | HOLLOW | | ELECTRIFICATION | | | | | | |
|---|---|---|---|---|---|---|---|---|---|---|---|---|
| | | VOLUME- | | CHARACTER | | AMOUNT (μC/g) | | | IMAGE DENSITY | | | |
| | | AVERAGE | AMOUNT | | AFTER | | AFTER | | | | AFTER | |
| | | PARTICLE | OF ZINC | | PRINTING | | PRINTING | | | | PRINTING | |
| | | DIAMETER | STEARATE | INI- | ON 100,000 | | ON 100,000 | TONER | | | ON 100,000 | |
| | | (μm) | (PART) | TIAL | SHEETS | INITIAL | SHEETS | SCATTERING | INITIAL | | SHEETS | |
| EXAMPLE 1 | Black | 8.2 | 0.1 | ⊚ | ⊚ | 19.5 | 17.6 | ◯ | 1.35 | ◯ | 1.51 | ◯ |
| | Yellow | 8.4 | 0.07 | | | 25 | 23.2 | ◯ | 1.25 | Δ | 1.31 | ◯ |
| | Cyan | 8.5 | 0.04 | | | 24.5 | 22.1 | ◯ | 1.28 | Δ | 1.35 | ◯ |
| | Magenta | 8.3 | 0.01 | | | 23.8 | 23 | ◯ | 1.3 | ◯ | 1.31 | ◯ |
| EXAMPLE 2 | Black | 8.2 | 0.5 | ⊚ | Δ | 18.8 | 15.2 | Δ | 1.4 | ◯ | 1.55 | ◯ |
| | Yellow | 8.4 | 0.07 | | | 25 | 23.2 | ◯ | 1.24 | Δ | 1.33 | ◯ |
| | Cyan | 8.5 | 0.04 | | | 24.5 | 22.1 | ◯ | 1.28 | Δ | 1.31 | ◯ |
| | Magenta | 8.3 | 0.01 | | | 23.8 | 23 | ◯ | 1.33 | ◯ | 1.28 | Δ |
| EXAMPLE 3 | Black | 8.2 | 0.1 | ◯ | ◯ | 19.5 | 17.6 | ◯ | 1.34 | ◯ | 1.46 | ◯ |
| | Yellow | 8.4 | 0.06 | | | 25.8 | 23.2 | ◯ | 1.21 | Δ | 1.31 | ◯ |
| | Cyan | 8.5 | 0.07 | | | 23 | 20.6 | ◯ | 1.3 | ◯ | 1.4 | ◯ |
| | Magenta | 8.3 | 0.01 | | | 23.8 | 23 | ◯ | 1.3 | ◯ | 1.29 | Δ |
| EXAMPLE 4 | Black | 8.2 | 0.1 | Δ | Δ | 19.5 | 17.6 | ◯ | 1.33 | ◯ | 1.5 | ◯ |
| | Yellow | 8.4 | 0 | | | 25.3 | 26.8 | ◯ | 1.26 | Δ | 1.2 | Δ |
| | Cyan | 8.5 | 0 | | | 25.2 | 26.8 | ◯ | 1.23 | Δ | 1.21 | Δ |
| | Magenta | 8.3 | 0 | | | 24.8 | 27.1 | ◯ | 1.27 | Δ | 1.21 | Δ |
| COMPARATIVE | Black | 8.2 | 0.07 | X | X | 22.5 | 20.1 | ◯ | 1.21 | Δ | 1.25 | Δ |
| EXAMPLE 1 | Yellow | 8.4 | 0.1 | | | 24 | 21.3 | ◯ | 1.26 | Δ | 1.29 | Δ |
| | Cyan | 8.5 | 0.04 | | | 24.5 | 22.1 | ◯ | 1.22 | Δ | 1.3 | ◯ |
| | Magenta | 8.3 | 0.01 | | | 23.8 | 23 | ◯ | 1.29 | Δ | 1.22 | Δ |
| COMPARATIVE | Black | 8.2 | 0 | X | X | 23.6 | 25.4 | ◯ | 1.18 | X | 1.1 | X |
| EXAMPLE 2 | Yellow | 8.4 | 0 | | | 25.3 | 27.8 | ◯ | 1.11 | X | 1.11 | X |
| | Cyan | 8.5 | 0 | | | 25.2 | 26.8 | ◯ | 1.14 | X | 1.08 | X |
| | Magenta | 8.3 | 0 | | | 24.8 | 27.1 | ◯ | 1.19 | X | 1.13 | X |
| COMPARATIVE | Black | 8.2 | 0.01 | X | X | 23 | 21.2 | ◯ | 1.15 | X | 1.22 | Δ |
| EXAMPLE 3 | Yellow | 8.4 | 0.04 | | | 26.2 | 23.8 | ◯ | 1.2 | Δ | 1.28 | Δ |
| | Cyan | 8.5 | 0.07 | | | 23 | 20.6 | ◯ | 1.24 | Δ | 1.36 | ◯ |
| | Magenta | 8.3 | 0.1 | | | 22.4 | 18.8 | ◯ | 1.22 | Δ | 1.44 | ◯ |
| COMPARATIVE | Black | 8.2 | 0.06 | ◯ | X | 25.4 | 23 | ◯ | 1.22 | ◯ | 1.3 | ◯ |
| EXAMPLE 4 | Yellow | 8.4 | 0.07 | | | 25 | 23.2 | ◯ | 1.2 | Δ | 1.26 | Δ |
| | Cyan | 8.5 | 0.04 | | | 24.5 | 22.1 | ◯ | 1.22 | Δ | 1.25 | Δ |
| | Magenta | 8.3 | 0.01 | | | 23.8 | 23 | ◯ | 1.23 | Δ | 1.24 | Δ |

As shown in Table 1, Examples 1 to 4, in which the respective content of zinc stearate, with respect to 100 parts of toner particle, in the black developer placed most downstream, in the yellow developer placed upstream thereof, in the cyan developer placed upstream of the yellow developer, and in the magenta developer placed most upstream in the travelling direction of the intermediate transfer body satisfies the relationships represented by Formulae (I) and (II) described above, showed definitely smaller hollow character phenomenon and gave an image higher in density than Comparative Examples 1 to 4 in which the contents of zinc stearate did not satisfy the relationship of Formula (I) or (II). In particular, Example 1, in which the zinc stearate concentration in the most downstream black developer was low, gave no hollow character, and thus, was more advantageous than Example 2 in which the concentration is higher, Example 3 in which the relationship of Formula (III) above was not satisfied, or Example 4 in which the developer upstream of the black developer did not contain zinc stearate. There was no incomplete electrification in any Example.

As described above, a tandem image forming apparatus comprises multiple image forming units placed along the travelling direction of a transfer medium for transferring toner images in various colors one by one onto the transfer medium, wherein a toner (T1) containing a higher fatty acid metal salt is stored at least in the image forming unit placed most downstream in the travelling direction of the transfer medium. When the concentration of the higher fatty acid metal salt in the toner (T1) is designated as X1, the concentration of the higher fatty acid metal salt in the toner (Tn) stored in the image forming unit placed most upstream in the travelling direction of the transfer medium as Xn, and the concentration of the higher fatty acid metal salt in the toner (Tm) stored in an image forming unit placed between the most downstream image forming unit and the most upstream image forming unit concentration as Xm, X1, Xm, and Xn satisfy the relationships represented by the following Formulae (I) and (II).

X1>Xn (I)

X1≧Xm≧Xn (II)

In the above configuration, it is possible to reduce the friction resistance of image carrier effectively and thus, to prevent hollow character phenomenon and also incomplete electrification, resulting in a stabilized image.

In addition, when there are multiple image forming units placed between the most downstream image forming unit and the most upstream image forming unit, the concentration of the higher fatty acid metal salt in each toner stored in an upstream image forming unit is preferably similar to or smaller than that in the toner stored in the downstream neighboring image forming unit.

The configuration enables to prevent the hollow character phenomenon and the incomplete electrification more reliably.

Further, the toner (T1) preferably contains the higher fatty acid metal salt in an amount of 0.01 to 0.5 mass % with respect to the toner particle; the toner (Tn) in an amount of 0.001 to 0.02 mass % with respect to the toner particle; and the toner (Tm) in an amount of 0.02 to 0.1 mass % with respect to the toner particle.

In the above arrangement, it is possible to prevent the hollow character phenomenon and reduce incomplete electrification while keeping the higher fatty acid metal salt content lower.

The higher fatty acid metal salt is preferably a salt of at least one fatty acid selected from straight-chain saturated fatty acids having 12 to 22 carbon atoms and at least one metal selected from zinc, magnesium, calcium and aluminum.

Such higher fatty acid metal salt makes it possible to reduce the friction resistance of image carrier effectively.

The higher fatty acid metal salt is preferably zinc stearate. Zinc stearate reduces the friction resistance of image carrier more efficiently.

Each of the multiple image forming units has preferably an amorphous silicon drum, respectively.

An amorphous silicon drum having a higher friction resistance easily causes the hollow character phenomenon, but above configuration enables to prevent it effectively.

This application is based on patent application No. 2006-073884 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A tandem image forming apparatus, comprising multiple image forming units placed along the travelling direction of a transfer medium for transferring toner images in various colors one by one onto the transfer medium, wherein
a toner (T1) containing a higher fatty acid metal salt is stored at least in the image forming unit placed most downstream in the travelling direction of the transfer medium, and,
when the concentration of the higher fatty acid metal salt in the toner (T1) is designated as X1, the concentration of the higher fatty acid metal salt in the toner (Tn) stored in the image forming unit placed most upstream in the travelling direction of the transfer medium as Xn, and the concentration of the higher fatty acid metal salt in the toner (Tm) in an image forming unit placed between the most downstream image forming unit and the most upstream image forming unit as Xm, X1, Xm, and Xn satisfy the relationships represented by the following Formulae (I) and (II).
X1≧Xn (I)
X1≧Xm≧Xn (II)

2. The image forming apparatus according to claim 1, wherein, when multiple image forming units are placed between the most downstream image forming unit and the most upstream image forming unit, the concentration of the higher fatty acid metal salt in each toner stored in an upstream image forming unit is similar to or smaller than that in the toner stored in the next downstream image forming unit.

3. The image forming apparatus according to claim 1, wherein the toner (T1) contains the higher fatty acid metal salt in an amount of 0.01 to 0.5 mass % with respect to the toner particle.

4. The image forming apparatus according to claim 1, wherein the toner (Tn) contains the higher fatty acid metal salt in an amount of 0.001 to 0.02 mass % with respect to the toner particle.

5. The image forming apparatus according to claim 1, wherein the toner (Tm) contains the higher fatty acid metal salt in an amount of 0.02 to 0.1 mass % with respect to the toner particle.

6. The image forming apparatus according to claim 1, wherein the higher fatty acid metal salt is a salt of at least one fatty acid selected from straight-chain saturated fatty acids having 12 to 22 carbon atoms and at least one metal selected from zinc, magnesium, calcium and aluminum.

7. The image forming apparatus according to claim 6, wherein the higher fatty acid metal salt is zinc stearate.

8. The image forming apparatus according to claim 1, wherein each of the multiple image forming units has an amorphous silicon drum.
